(19) United States
(12) Patent Application Publication
(10) Pub. No.: US 2011/0275321 A1
(43) Pub. Date: Nov. 10, 2011

(54) Integrated Vehicle Key and Mobile Phone System for Preventing Mobile Phone Use While Driving

(76) Inventors: Xuesong Zhou, Sandy, UT (US); Wallace Curry, Hays, KS (US)

(21) Appl. No.: 13/127,186

(22) PCT Filed: Oct. 30, 2009
(86) PCT No.: PCT/US09/62788

§ 371 Date: Jun. 28, 2011

Related U.S. Application Data
(60) Provisional application No. 61/110,340, filed on Oct. 31, 2008.

(51) Int. Cl. H04W 4/04

(52) U.S. Cl. 455/41.2

(57) ABSTRACT

A system and method for controlling wireless communications in a vehicle is disclosed. The system comprises a vehicle key (102) configured to communicate with the vehicle (107). A vehicle key code is configured to identify the vehicle key (102) to the vehicle (107) and associate the vehicle key (102) with a particular user of the vehicle. A mobile computing device (110) can be wirelessly connected with the vehicle key (102) or physically integrated with the vehicle key (102), and it is configured to identify when the vehicle (107) is activated using the vehicle key (102). Selected device features of the mobile computing device (110) are controlled when the vehicle (107) is activated using the vehicle key (102).

### BACKGROUND

In 2007, statistics show that about 84% of the US population subscribed to a form of wireless mobile phone service. Approximately 6% of automobile drivers admitted to using hand-held phones while driving. The actual number of drivers using wireless devices is likely much greater. Researchers have shown that using mobile phones while driving is four times as likely to get into crashes, and the increased crash risk is similar for hands-free and hand-held phones.

The U.S. Department of Transportation has launched numerous programs and initiatives to reduce traffic-related fatalities and injuries. Many states explicitly prohibit talking, text-messaging or playing video games on hand-held mobile phones while driving. Additionally, a number of states, such as California, have passed laws banning or restricting young drivers (under age 18) from using mobile phones, or other types of mobile devices while driving. However, a recent study in North Carolina finds that teenagers seem to ignore such restrictions. A ban on the use of wireless devices by teenagers while driving was enacted in Spring, 2007. The study found that approximately 11% of teenage drivers observed departing 25 high schools were using mobile phones during the two months before the restrictions were enacted, while about 12% of teenage drivers were observed using mobile phones during the five months after the enactment of the restrictions.

Two categories of solutions have been proposed to detect the motion state of a car or a cell phone for further preventing cell phone usage while driving. (1) Embedded mechanical/electronic detectors can be used in a vehicle. In this aspect, detectors need to be installed and associated with a car ignition switch or gear shift level, and then motion state signals such as “driving vs. stopped” are sent wirelessly to a mobile phone inside a car to allow or disable the use of phone communication capabilities. (2) Alternatively, or in combination, an embedded GPS or motion sensors such as accelerometers in mobile phones can be used to detect movement and vehicle travel. GPS location data or other types of motion data are extracted from embedded GPS receiver or motion sensors in a cell phone to estimate the motion state of a cell phone user. If the prevailing moving speed of a cell phone exceeds a predetermined threshold, then the communication functions are typically disabled.

The first type of solutions requires hardware installation by mounting an accessory in a car. The mechanical and electronic modifications need to be customized for different models of automobiles, which can be difficult for many newer cars because of the anti-theft devices used in cars. Without customized user control, all the phone services inside the vehicle or the immediate proximity can be blocked. The Federal Communications Commission (FCC) in the United States does not allow the sale and use of cell phone jammers, because they can block or interfere with emergency communications.

The GPS-based approach also has difficulties and limitations. After waking up from the standby mode, a GPS receiver needs an extended time period (10-30 seconds) to fetch the first few GPS location samples to calculate reliable space mean speed. Thus, a GPS may not accurately predict when a cell phone is traveling at a high rate of speed. In addition, a non-driving cell phone user in a public bus or a passenger car cannot use cell phones having motion detection systems since the high rate of speed indicates the user may be driving. In addition, when the motion speed is low, it is difficult to distinguish between walking vs. driving modes using GPS.

### SUMMARY

A system and method for controlling wireless communications in a vehicle is disclosed. The system comprises a vehicle key configured to communicate with the vehicle. A vehicle key code is configured to identify the vehicle key to the vehicle and associate the vehicle key with a particular user of the vehicle. A mobile computing device is configured to identify when the vehicle is activated using the vehicle key. Selected device features of the mobile computing device are controlled when the vehicle is activated using the vehicle key. The mobile computing device can be configured to identify when the vehicle is activated through communication of the mobile computing device directly with the vehicle key. Alternatively, the mobile computing device can be configured to identify when the vehicle is activated by communicating directly with the vehicle. In one embodiment, the vehicle key code can be integrated directly into the mobile computing device. The mobile computing device can then be used to activate the vehicle directly. The vehicle can then directly communicate with the mobile computing device.

For example, the vehicle can be configured to communicate operational information wirelessly to the mobile computing device to enable the mobile computing device to determine which of the selected device features are operable based on the operational information. The operational information can include such information as the time of day, the vehicle speed, and the vehicle location.

A graphical user interface (GUI) can be used to communicate with the mobile computing device. For example, the mobile computing device can be connected to the internet or another computer. The GUI can be used to control which of the mobile devices features will be operable based on the operational information. Features that can be turned on, off, or altered based on the operational information include the ability to make outgoing phone calls, outgoing voice messaging, text messaging, gaming, emailing, calendaring, and view the mobile device display.

When the vehicle is shut off using the vehicle-key system, full control of all of the mobile device features can be returned to the mobile device. In one embodiment, full control can be returned immediately after the vehicle is shut off. Alternatively, full control may be returned after a predetermined period, such as 30 seconds. The mobile computing device can determine that the vehicle is shut off when the key code is not transmitted to the mobile computing device for a certain amount of time, such as 5 seconds.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1a is a block diagram of a system for controlling wireless communications in a vehicle in accordance with an embodiment of the present invention.

FIG. 1b is a block diagram of a system for controlling wireless communications in a vehicle having a wireless key system in accordance with an embodiment of the present invention.

FIG. 2 is an exemplary illustration of a mobile computing device having an integrated key code.

FIG. 3 is a flow chart depicting phone usage handling after the vehicle key is used to start the car engine in accordance with an embodiment of the present invention.

FIG. 4 is a flow chart depicting phone usage after the car engine is turned off in accordance with an embodiment of the present invention.

FIG. 5 is a flow chart depicting phone usage after a phone is turned on in accordance with an embodiment of the present invention.

FIGS. 6a and 6b are an exemplary illustration of a mobile computing device configured to receive a vehicle key in accordance with an embodiment of the present invention.

FIG. 7 is an exemplary illustration of a mobile computing device mounting dock used to control the operational status of a vehicle in accordance with an embodiment of the present invention.

FIG. 8 is an exemplary illustration of a user ID transmission bridge configured to enable a mobile computing device to communicate with a key fob in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

In accordance with one embodiment, a method is disclosed for controlling the use of a mobile phone while the user is driving an automobile. While the term “mobile phone” is used throughout the specification, it is not intended to be limiting. The term mobile phone can include any type of wireless mobile computing device.

In accordance with one embodiment, a method for controlling wireless communication in a moving vehicle is disclosed. A car-key system and mobile phone can be configured to communicate through a communication means, such as Bluetooth, Radio-frequency identification (RFID) or a data cable to enable the mobile phone to be associated with the car-key system.

In one embodiment, an embedded transmitter can be coupled to a traditional automobile key. The embedded transmitter can include a button switch or a starter button. In one embodiment, actuation of the button may release the key, enabling the key to be used to activate the automobile, such as starting the car engine or allowing the electric motor(s) to be used.

When the button is actuated, the embedded transmitter in the car-key system can be wirelessly connected to a nearby mobile phone that is located within a relatively short range of the car-key system. The wireless link can be a short range wireless communication protocol, such as Bluetooth or RFID. Such a short range wireless protocol can be used to limit the amount of battery power needed to communicate between the car-key system and the mobile phone.

After the key system is used to turn off the car engine, the wireless transmitter can automatically disconnect the wireless communication link with the associated mobile phone, if the connection has been established previously when the key is used to start the engine.

An enhanced key system for an automobile using a traditional physical key can comprise the traditional key, a wireless communication transmitter coupled to the key that is configured to communicate between the key and the mobile phone, and a receiver coupled to the automobile to communicate between the key, and in some embodiments, with the mobile computing device. For an automobile having a remote keyless system, instead of having a traditional key, a wireless key fob transceiver is configured to send a security code to a receiver in an automobile. The wireless key fob transceiver can be configured to send a signal, such as the security code, to the mobile computing device as well.

Communication between the key, mobile computing device, and vehicle can be accomplished using a low power, short range communication means, such as Bluetooth, Zigbee, or through the use of Radio-Frequency Identification (RFID) chips embedded in the vehicle key and/or mobile computing device. The mobile computing device can include a digital telephonic communication system that can communicate with a telephone system using a radio frequency connection. The device may communicate using a standard connection such as GSM/GPRS, or another standard used for mobile phone transmission.

Enabling a person's unique vehicle key to communicate with the person's mobile phone facilitates controlling use of the person's mobile phone while the person is driving, while allowing use of the person's mobile phone in a moving vehicle when the person is not driving. Use of the phone is not blocked based on delayed or inaccurate GPS data or unreliable mode recognition results which can lead to incorrect disruption of cell phone services that lead to unpleasant user experiences.

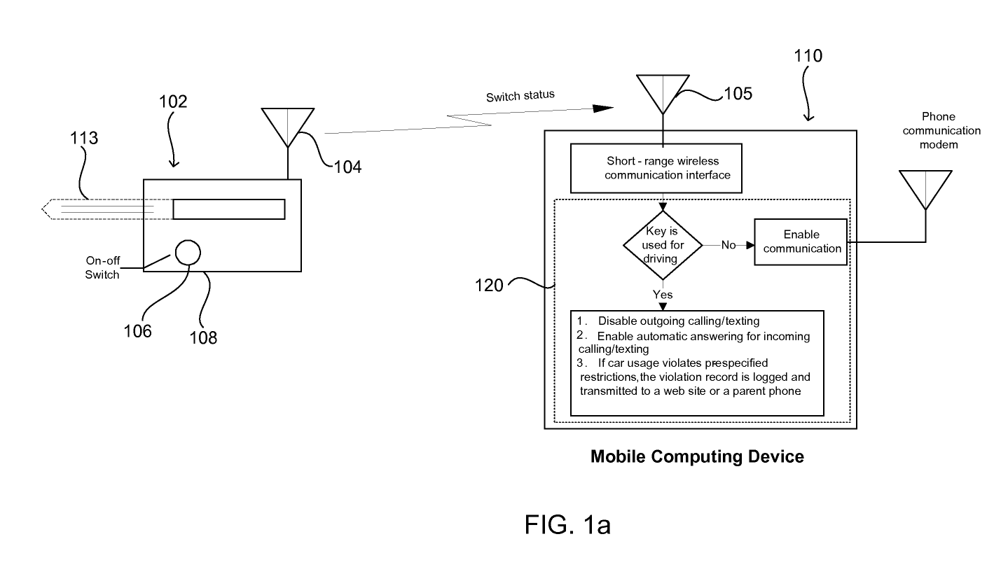

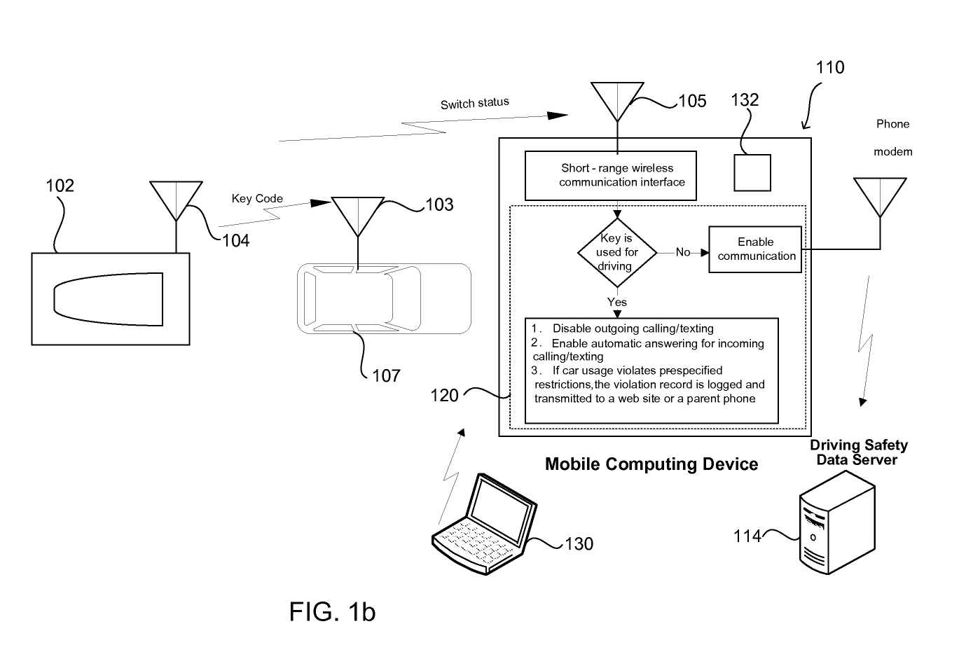

In one embodiment, the present invention provides a method for monitoring the usage state of a motor vehicle based on a signal transmitted between a vehicle key transceiver 104 and a mobile computing device transceiver 105. The vehicle key 102 can include a wireless transceiver 104 and an on-off button 106, as illustrated in FIG. 1a. In the key illustrated in FIG. 1, the on-off button may be a mechanical button used to initiate the ejection of a mechanical key 113 from the key body 108 to enable the mechanical key to be inserted into the vehicle. When the mechanical key is ejected from the key body 108, a short range radio frequency signal can be sent from the wireless transceiver 104 to the transceiver 105 on the mobile computing device 110. The signal can indicate that the mechanical key 113 has been placed in a position to be inserted into the vehicle to make the vehicle operational. When the key is in this position, the signal sent to the mobile computing device transceiver 105 can be used to place the mobile computing device 110 in a selected mode, such as a driving mode, which can limit the functions and capabilities of the mobile computing device 110. A software monitoring module 120 can be installed on the mobile computing device to provide the functionality needed to interpret the signal sent from the vehicle key 102, or the vehicle, that indicates that the vehicle key is being used to activate the vehicle. The software monitoring module 120 can also be used to control the functionality of the mobile computing device 110.

For example, outbound wireless communication from the mobile computing device 110 can be disabled or restricted. The restriction can include limitations on outgoing phone calls, outgoing voice messaging, text messaging, gaming, emailing, calendaring, and mobile device display. Other limitations on functionality of the mobile computing device can be restricted as desired. Automatic answering can be enabled for incoming phone calls or texting to the mobile computing device. In one embodiment, incoming calls may be answered with a message that the owner of the mobile computing device is currently driving and will respond to the call as soon as convenient. The caller can leave a message or choose to call back later. Optionally, restrictions can be tailored (increased or decreased) depending on whether a hands-free device is being used and assessment of a user or responsible party (e.g. parent, insurer, etc.) as to risk level associated with hands-free usage.

In another embodiment illustrated in FIG. 1b, a vehicle transceiver 103 and the vehicle key transceiver 104 may communicate wirelessly. No mechanical connection may actually be used between the key 102 and the vehicle 107 in order to make the vehicle operational. In this case, a specific code can be communicated to the vehicle transceiver 103 from the vehicle key transceiver 104. This code can be sent to enable the vehicle to become operational. When the vehicle key containing an appropriate code is present within the vehicle, or within a predetermined distance of the vehicle, the vehicle can be activated. For example, the activation of the vehicle can include starting the vehicle by depressing a “start button” on the vehicle. When the start button is depressed, the vehicle transceiver 103 can send a query to the key transceiver 104. The key transceiver can send a response signal to the query by sending the specific code to the vehicle transceiver 103 to allow the vehicle 107 to be activated. The vehicle can stay in continuous communication with the key. If the engine is turned off, and the vehicle key 102 is only used to activate the vehicle's power, such as listening to the radio in the vehicle without the engine running, a link between the mobile computing device 110 and the vehicle transceiver 103 or key transceiver 104 can be severed to preserve battery power. Alternatively, the vehicle may ping the key. Pinging can consist of sending a message to the key to ask for its code at a predetermined frequency, such as once per second.

The signal sent from the key transceiver 104 to the vehicle transceiver 103 can also be received by the mobile computing device transceiver 105. When the signal is received at the mobile computing device 110, the functionality of the mobile computing device can be controlled, as previously discussed.

In another embodiment, the vehicle key transceiver 104 can communicate with the vehicle transceiver 103. The vehicle transceiver 103 can then be used to communicate directly with the mobile computing device transceiver 105. By using the vehicle 107 to communicate with the mobile computing device 110, the amount of energy output from the vehicle key 102 can be minimized, thereby extending the vehicle key battery life. Moreover, additional information may be communicated from the vehicle 107 to the mobile computing device 110.

Rather than merely identifying whether the vehicle 107 is in an on or off state, additional information such as vehicle speed, time of day, and vehicle location can be communicated from the vehicle to the mobile computing device. Vehicle speed information can be used to alter the limitations that are placed on the mobile computing device. For example, when the vehicle speed is at zero, substantially all limitations may be lifted, allowing the computing device to operate normally. At low speeds, such as speeds below 10 miles per hour (MPH), outgoing telephone calls may be allowed, while blocking texting and game playing. This can enable a user to communicate while stuck in stop-and-go traffic.

The limitations can also be adjusted based on other conditions such as the time of day, the location, or the type of driver. For example, when a mobile phone is used by a new teenage driver, an aging parent, or an employer seeking to minimize liability, outgoing communications from the mobile computing device 110 may be turned off whenever the vehicle 107 is moving to encourage the driver to devote maximum attention to operating the vehicle. The limitations may be extended for a certain period of time, such as 30 seconds, even after a vehicle has stopped to discourage outgoing calls and texting during stop and go traffic.

In one embodiment, at least one of the vehicle 107, vehicle key 102, and the mobile computing device 110 can include safety protocols that make it difficult to disable the wireless link between the mobile computing device and the vehicle key or the link between the vehicle and the mobile computing device. For example, when a young driver is given their first car to drive, a parent or guardian can ensure the software monitoring module 120 is installed on the youth's mobile computing device 110 and the mobile computing device can be paired with the youth's vehicle key. If the pairing is turned off, thereby disabling the connection between the devices, the software monitoring module can be configured to transmit information, such as a text, to a predetermined location, such as to a parent, guardian, or employer notifying them that the paring has been turned off. In addition, the vehicle key module 102 can be equipped with a data memory to record the wireless connection communication status each time the vehicle is turned on and off, thereby enabling a person monitoring the transmitted data to determine if the vehicle had been operated without the wireless communication link.

In one embodiment, the software monitoring module 120 in the mobile computing device 110 can be in communication with a built-in accelerometer 132 to detect the motion status of the mobile computing device and accordingly turn on and off a wireless connection link with the vehicle key 102 or the vehicle 107. For example, when the mobile computing device remains substantially immobile for a long time, e.g. 10 min, the mobile computing device can automatically turn off a Bluetooth communication channel to save battery usage. When a predetermined amount of phone motion is sensed by the accelerometer, the wireless communication can be resumed and the link can be reestablished. By doing so, a mobile computing device with the monitoring software module 120 installed can use less battery power, thereby enabling the battery to be recharged less frequently.

In another embodiment, the software monitoring module 120 on the mobile computing device 110 can be configured to log the amount of time that the vehicle is driven with the associated vehicle key. The software monitoring module can be configured to transmit a warning message to a desired location, such as a parent or supervisor's mobile phone, if the wireless link has been connected for a certain extended period of time (e.g. one week). In another embodiment, the software monitoring module on the mobile computing device can be configured to transmit a warning message if a user attempts to uninstall the software package. In addition, a parent or supervisor can provide a rough estimate of monthly driving time for their children or employees. If the paired key and mobile computing device are not used together or are not working properly, then the amount of driving time logged will be significantly less than average in the software monitoring module. In this case, a warning message can be sent to the parents or supervisor, allowing them to correct the problem. The above connection checking rules can be used to detect the following potential problems: (1) when the key is exposed for an extended period of time to kill the battery to avoid the limitations to the user's mobile phone device; (2) when the user is using another person's cell phone; and (3) when the user is using another key to avoid limitations to the user's mobile phone.

In one embodiment, rather than strictly enforcing usage rules by limiting the functionality of the wireless computing device 110, device usage may be stored within the device. The usage information can be sent through a wireless connection from the wireless computing device to a remote data server 114 configured to monitor usage information, as shown in FIG. 1b. Car usage restrictions, such as permissible schedules and locations, can be input to the mobile phone. If the received signal shows the vehicle key is used to operate the vehicle and the previously entered car usage restriction violates the pre-specified restrictions, the violation record can be logged and transmitted to the remote data server or a parent or supervisor mobile phone. The driving data and safety violation data can be further used in a usage based insurance system which adjusts insurance rates and/or discounts based on collected data. In one embodiment, the information may only be sent if pre-specified restrictions are violated, such as phone use above a predetermined limit. For example, if a driver is using his or her mobile phone while driving faster than 25 miles per hour, the information may be sent to an external source, as previously discussed.

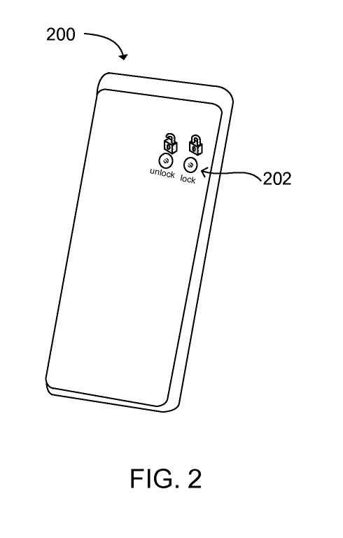

In another embodiment, an electronic vehicle key can be incorporated directly in a mobile computing device, thereby reducing the number of electronic devices a user needs to carry. For example, in 2004, the Nokia Mobile RFID Kit was combined with the Nokia 5140 mobile phone to form the first GSM phone integrated product offering with RFID reading capability. RFID technology has been used in many urban mass-transit systems for passengers to make electronic payments. In another example, as illustrated in FIG. 2, a wireless phone network provider NTT DoCoMo and electronics maker Sharp have developed a prototype mobile phone 200 that doubles as an intelligent ignition key for automobiles. The system provides an integrated intelligent key that uses two-way wireless communications capable of triggering the doors or engine of a vehicle without requiring a separate key. In this example, the mobile phone can be in direct communication with the vehicle. A user can lock and unlock doors using buttons 202 located on a face of the phone 200. The phone can communicate an electronic ID that enables the vehicle to start, as previously described. The vehicle can transmit signals to the integrated phone-key system. When the vehicle is activated, various limitations can be applied to the mobile phone 200, as previously discussed.

In one embodiment, the specific key code transmitted by a key can be associated with a particular user. For example, a vehicle owner can have multiple keys, one for a child, and keys for each parent. In a commercial setting, each employee can be assigned his or her own key. Each key can have a unique key code, thereby identifying the driver using the key. Different restrictions may be applicable to the different users of the vehicle. When a user is not driving the vehicle, his or her mobile computing device will still be operable since there won't be a link between their key, the vehicle, and/or their mobile computing device. This provides a significant advantage over other systems that seek to measure when a mobile phone is traveling at a rate of speed. Systems that use speed to determine when a user is driving can result in a user's inability to use their phone whenever they are moving above a selected rate of speed. Thus, they may be limited when they are a passenger in a car, a bus, or on a train.

Returning to FIG. 1b, a computer program can be used by the parents to setup restrictions for cell phone use while operating a vehicle. The vehicle owner can use a graphical user interface 130 to select which features of a selected mobile computing device 110 may be operated while the vehicle 107 is activated. For example, the vehicle owner can substantially limit the functions of the owner's child's phone. The child's phone can be associated with the child's key to the vehicle. When the child's key is used to operate the vehicle, a signal can be sent from at least one of the child's key and the vehicle to the child's phone (i.e. mobile computing device) to apply the predetermined limitations. Alternatively, the child's phone can include software that can be setup to apply the predetermined limitations when the signal from the child's key and/or vehicle indicates that the child is operating the vehicle. Similarly, the owner can apply selected limits to the owner's mobile computing device and the owner's spouse's mobile computing device, which can each be associated with a separate electronic or physical key used to operate the vehicle. The same process can also be used by employers and employees when operating employee owned vehicles.

The limitations applied to a mobile computing device can be universal, or selected based on time and user. For example, a teenager's cell phone can be setup to minimize usage while driving during daytime hours. This can maximize the teenager's attention to driving, especially when the teenager may have other teens in the car on the way to school or lunch. However, outgoing calls to a select number of phone numbers may be allowed during night time hours to allow the teenager to make calls during an emergency while traveling to his or her job or home.

Additionally, selected emergency numbers, such as 911, and first responder phone numbers such as police and fire telephone numbers can be allowed no matter the driving conditions. Thus, even if a driver is driving at a high rate of speed, the mobile computing device 110 can still be used to place emergency phone calls. All the emergency calls can be logged and the parents or supervisor can be notified immediately.

By using a signal from the vehicle key transceiver 104 or the vehicle transceiver 103, the mobile computing device 110 does not need to include additional components such as a global positioning satellite (GPS) receiver and accelerometer to determine when the device 110 is being used while driving. This can enable less expensive mobile computing devices, such as relatively simple mobile phones to be used in conjunction with calling limitations to increase the safety of drivers and allow control of selected users. The use information can be logged for use by parents, insurance companies, and so forth on the mobile computing device. This information can then be downloaded or transmitted to its intended recipient, as previously discussed.

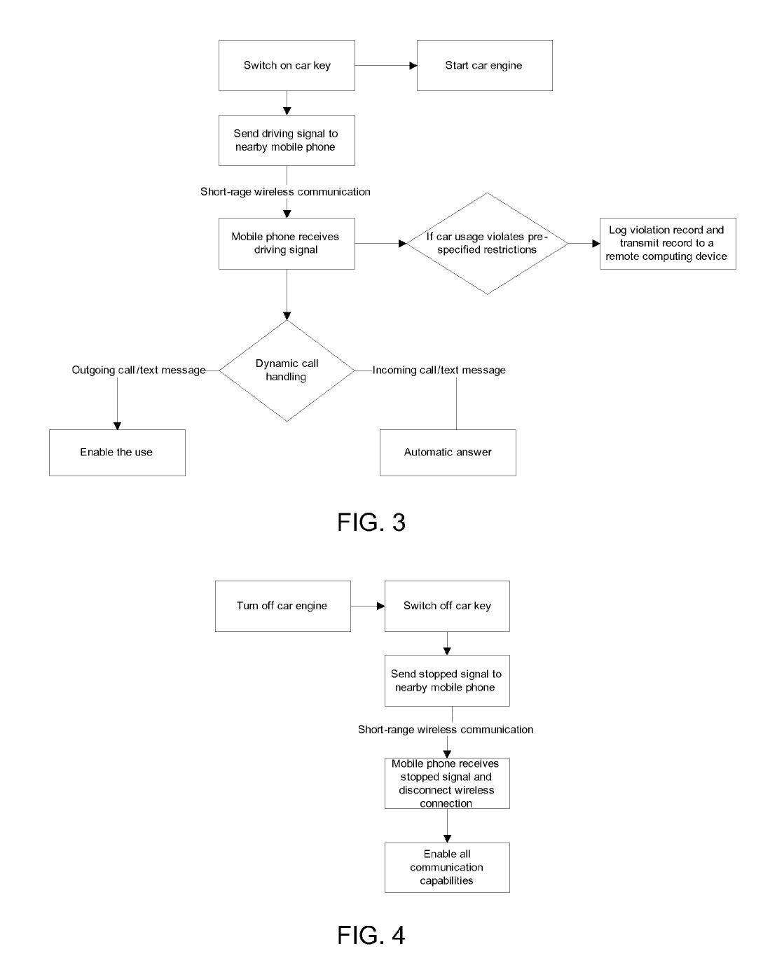

FIG. 3 provides a flow chart for phone usage handling after a key is used to activate a car. A vehicle key is used to start the car engine, and then a “driving” signal is sent from the key to a designated nearby mobile computing device wirelessly through a short-range communication protocol, such as Bluetooth. When the mobile computing device receives the “driving” signal, the activity mode of the mobile phone integrated in the mobile computing device is set to a driving mode. In this mode, a dynamic call handling module can allow or disallow users to receive or make a call, text a message or play games. For an incoming call, a “user is driving” message may be sent to the caller. Dependent on the pre-specified priority of a caller, the cell phone user is notified by different ringtones for different callers so that a decision can be made if the mobile computing device user needs to pull over to receive the call, or ignore the current call and make a call back after the user arrives at his/her destination. The dynamic call handling module also determines if the cell phone is allowed to use the mobile computing device based on use permission data received from the server. If the car usage violates the pre-specified restrictions, the violation record can be logged and transmitted to a remote computing device such as a data server or a parent/supervisor's mobile computing device. The driving data and safety violation data can be further used in a usage based insurance system.

FIG. 4 depicts a flow chart for phone usage after a car engine is turned off. When a vehicle key is used to turn off the car engine, a “stopped” signal is sent to a designated nearby mobile phone wirelessly through a short-range communication protocol. When the mobile phone receives the “stopped” signal, the activity mode of the mobile phone is set to a communication mode, and then the mobile phone disconnects the wireless connection that it previously established with the vehicle key system. In the communication mode, all the communication capabilities of the mobile phone are enabled. The enablement of communication capabilities may be delayed by a set time period, such as 30 seconds, to limit the use of the mobile computing device at stop signs and in stop and go traffic.

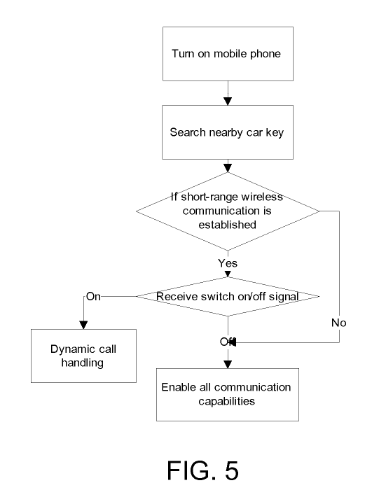

FIG. 5 provides a flow chart for phone usage after a mobile phone is turned on. The procedure shown in FIG. 5 is designed to handle the following special situations: when a vehicle key is used to turn on the vehicle engine, the designated mobile phone may be turned off at that time. A user might try to turn on the phone in the middle of his/her driving process. When a mobile phone is turned on, it can be configured to search for a nearby designated vehicle key using a short range wireless communication protocol, such as Bluetooth or Zigbee, as previously discussed. If a connection can be established, the mobile phone will check if the vehicle key is currently used for driving. If the key is used for driving, then the previously described dynamic call handling process is activated. Otherwise, all communication capabilities of the mobile phone are enabled.

Enabling the mobile computing device to communicate with a person's unique vehicle key can provide a more economical method for deploying a car key system with enhanced safety features to control mobile phone use while driving. Adding wireless communication interfaces to a vehicle's key is typically easier and less expensive than modifying hardware components inside a vehicle. In addition, mobile phones without embedded GPS and accelerometer sensors can also be controlled.

Wireless communication components can be powered in the car key system. UK-based chip maker CSR has demonstrated the first ultra-low power Bluetooth chip. The technology, previously known as Wibree, promises to enable wireless data communications from small devices powered by button sized batteries typically used in wrist watches with standby battery life of up to 10 years. Active RFID uses an internal power source (battery) within the tag to continuously power the tag and its RF communication circuitry, whereas Passive RFID relies on RF energy transferred from the reader to the tag to power the tag. Passive RFID does not require any battery. If RFID communication is used, a Mobile RFID Kit from Nokia is available to equip mobile phones with short-range communication capability, without using Bluetooth.

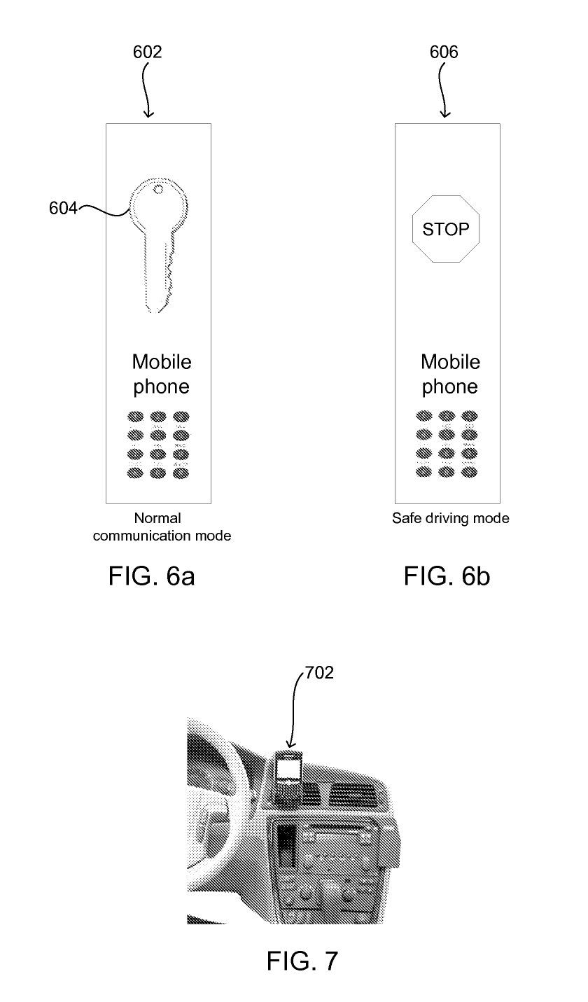

In another embodiment, the mobile computing device can be configured to receive a vehicle key. For example, FIG. 6a shows a mobile computing device 602 that is configured to receive a physical key 604. The vehicle key may be formed in other shapes, such as a plastic card, or a radio frequency identification (RFID) chip. When the key is mounted on the mobile computing device as shown in the mobile computing device 602, the device can have full functionality. When the key is removed from the mobile computing device 606, as shown in FIG. 6b, selected features of the mobile computing device can be limited or disabled, as previously discussed.

In another embodiment, a docking cradle 702 can be coupled to the vehicle, as shown in FIG. 7. The docking cradle can be connected to the vehicle ignition system or electrical system in such a way that the vehicle cannot be started unless the driver's mobile computing device is located in the docking cradle. In one embodiment, the mobile computing device can communicate with the vehicle key and/or the vehicle to verify that it is the driver's cell phone that is docked in the docking cradle. When the driver's cell phone is located in the docking cradle, selected device features can be limited or disabled, as previously discussed.

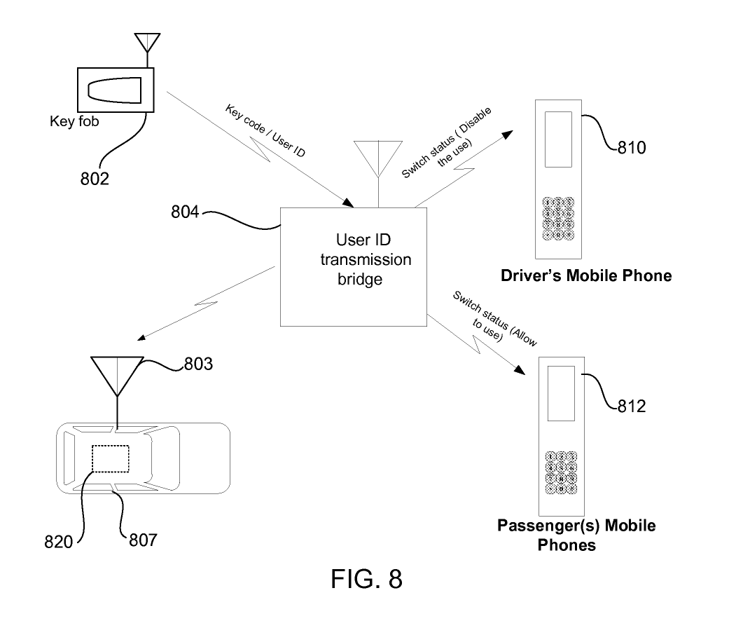

In another embodiment illustrated in one example in FIG. 8, a user ID transmission bridge 804 can be in communication with a vehicle 807. The transmission bride is configured to enable communications between the vehicle key 802 and the vehicle 807 to be bridged with communications between the driver's mobile computing device 810 and the vehicle. This can enable the vehicle key and the mobile computing device to communicate through the user ID transmission bridge. For example, the vehicle 807 may use a wireless key fob 802 to start or activate the vehicle. The wireless key fob is typically configured to communicate with the vehicle through a wireless link, such as an RFID chip in the key fob that communicates with the vehicle. Additionally, the vehicle can be configured to communicate with one or more mobile computing devices 810 through a short range wireless connection, such as a Bluetooth connection between the vehicle and the mobile computing device. The user ID transmission bridge can be enable the two communications streams between the vehicle and key and the vehicle and mobile computing device to be integrated in a way that it can allow the driver's vehicle key and the driver's mobile computing device to be linked, thereby enabling selected device features of the mobile computing device to be controlled when the driver is operating the vehicle.

For example, two people may operate a vehicle 807. Each person has their own key fob 802 and their own mobile computing device 810 and 812. Each person can create a Bluetooth link between their mobile computing device and the vehicle. They can also link their individual key fobs with the vehicle and link the key fob with their mobile computing device. This may be done using an electrical interface or a graphical user interface located either within the vehicle, or external to the vehicle. The vehicle can include a software monitoring module 820 configured to monitor when a mobile computing device having a Bluetooth link to the vehicle is located within the vehicle and the associated key fob is used to activate the vehicle. When this occurs, selected device features of the mobile computing device 810 can be controlled, as previously discussed. When a mobile computing device 812 is located within the vehicle, but is not linked to the key fob used to activate the vehicle, then the mobile computing device 812 of the passenger can remain fully operable. This is a significant advantage over controlling the use of cell phones using movement based detection systems, such as GPS, where the system is not able to distinguish between a driver's cell phone and a passenger's cell phone.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A system for controlling wireless communication in a vehicle, comprising:
a vehicle key configured to communicate with the vehicle;
a vehicle key code configured to associate the vehicle key with a particular user of the vehicle; and
a mobile computing device configured to identify when the vehicle is activated using the vehicle key, wherein selected device features of the mobile computing device are controlled when the vehicle is activated using the vehicle key.

2. A system as in claim 1, wherein the mobile computing device is configured to identify when the vehicle is activated through communication with the vehicle key.

3. A system as in claim 1, wherein the mobile computing device is configured to identify when the vehicle is activated through communication with the vehicle.

4. A system as in claim 3, wherein the vehicle is configured to communicate operational information wirelessly to the mobile computing device to enable the mobile computing device to determine which of the selected device features are operable based on the operational information.

5. A system as in claim 4, wherein the operational information is selected from the group consisting of a powered state of the vehicle, a time of day, a vehicle speed, and a vehicle location.

6. A system as in claim 1, further comprising a graphical user interface (GUI) in communication with the mobile computing device, wherein the GUI is configured to enable a user to select which of the device features on the mobile computing device are available for use when the vehicle is activated using the vehicle key.

7. A system as in claim 6, wherein the features on the mobile computing device that are controlled are selected from the group consisting of outgoing phone calls, outgoing voice messaging, text messaging, gaming, emailing, calendaring, and mobile device display.

8. A system as in claim 7, wherein the GUI is further configured to enable a user to select when selected features are operable while the vehicle is moving based on at least one of a time of day, the particular user that is associated with the key code, and a speed of the vehicle.

9. A system as in claim 1, wherein the vehicle key code is incorporated in the mobile computing device to enable the mobile computing device to be used as the vehicle key for the vehicle.

10. A system as in claim 1, wherein the mobile computing device is further configured to obtain full access to all of the selected features a predetermined amount of time after the vehicle has been turned using the vehicle key.

11. A system as in claim 1, wherein a data link between the mobile computing device and at least one of the vehicle key and the vehicle is deactivated when an accelerometer in the mobile computing device senses the mobile computing device has remained substantially immobile for a predetermined amount of time.

12. A system as in claim 1, wherein the mobile computing device is configured to receive the vehicle key and is fully functional only when the vehicle key is carried by the mobile computing device, wherein the vehicle key is comprised of at least one of an RFID tag, a plastic card, and a physical key.

13. A system as in claim 1, further comprising a docking cradle coupled to the vehicle that is configured to receive the mobile computing device, wherein the vehicle can only be started when the mobile computing device is located in the docking cradle and the mobile computing device has the selected device features disabled when located in the docking cradle.

14. A system as in claim 1, further comprising a user ID transmission bridge in communication with the vehicle that is operable to enable communications between the vehicle key and the vehicle to be bridged with communication between the mobile computing device and the vehicle to enable the vehicle key and the mobile computing device to communicate through the user ID transmission bridge.

15. A system as in claim 1, further comprising a software monitoring module operable on the mobile computing device and configured to monitor when the vehicle is activated with the vehicle key and transmit a warning message to a predetermined location when at least one of the following conditions are met:
a wireless link between the vehicle key and the vehicle has been connected for more than a predetermined time period;
a user attempts to uninstall the software monitoring module from the mobile computing device; and
the wireless link between the vehicle key and the vehicle has not been connected for at least a selected number of minutes over a predetermined time period indicating that at least one of the vehicle key and the mobile computing device may not be actively used together.

16. A method for controlling wireless communication in a moving vehicle, comprising:
monitoring a vehicle-key system comprising a vehicle and a vehicle key having a particular code to determine when the vehicle has been activated using the vehicle key;
communicating an operational state of the vehicle to a mobile computing device; and
controlling use of selected device features on the mobile computing device based on the particular code of the vehicle key when the operational state of the vehicle indicates that the vehicle is moving.

17. A method as in claim 16, further comprising communicating usage of the mobile computing device to a computer server configured to store usage records to enable the usage records to be accessed by a desired third party.

18. A method as in claim 16, wherein communicating an operational state of the vehicle further comprises communicating an operational state of the vehicle from the vehicle key to the mobile computing device.

19. A method as in claim 16, wherein communicating an operational state of the vehicle further comprises communicating an operational state of the vehicle from the vehicle to the mobile computing device.

20. A method as in claim 19, further comprising communicating an operational state of the vehicle from the vehicle to the mobile computing device, with the operational state selected from the group consisting of a powered state of the vehicle, a time of day, a vehicle speed, and a vehicle location.

21. A method as in claim 16, further comprising controlling which selected features of the mobile computing device are operable based on the operational state of the vehicle by using a graphical user interface.

22. A method as in claim 21, wherein controlling use of selected device features on the mobile computing device further comprises controlling the use of selected device features selected from the group consisting of outgoing phone calls, outgoing voice messaging, text messaging, gaming, emailing, calendaring, and mobile device display.

23. A method as in claim 21, further comprising controlling the use of selected device features on the mobile computing device using the GUI based on at least one of a time of day, the particular user that is associated with the key code, and a speed of the vehicle.

24. A method as in claim 16, wherein monitoring a vehicle-key system comprising a vehicle and a vehicle key having a particular code further comprises monitoring a vehicle-key system comprising a vehicle and a vehicle key having a particular code, wherein the vehicle key having the particular code is integrated in the mobile computing device to enable communication between the vehicle and the mobile computing device to determine when the vehicle has been activated using the integrated key.

25. A method as in claim 16, further comprising returning control of the selected features on the mobile computing device a predetermined period of time after the vehicle has been turned off using the vehicle-key system.
